(19) United States
(12) Patent Application Publication
(10) Pub. No.: US 2004/0073665 A1
(43) Pub. Date: Apr. 15, 2004

(54) Log management apparatus and storage medium

(75) Inventors: Tomohiro Fujiwara, Kawasaki (JP); Yasuhiro Hirano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/680,104

(22) Filed: Oct. 8, 2003

(30) Foreign Application Priority Data
Oct. 11, 2002 (JP) 2002-298826

(51) Int. Cl. G06F 15/173

(52) U.S. Cl. 709/224; 709/223

(57) ABSTRACT

A log management apparatus is coupled to a plurality of terminal equipments via at least one network and manages a log of a file operation performed from one of the plurality of terminal equipments with respect to a file of another one of the plurality of terminal equipments. An input and output section to obtain data via the network, and to obtain and store trace data in a trace file by starting a trace in response to a file operation, an extracting section to automatically extract predetermined modified contents with respect to a file from the trace file, and a storing section to store the predetermined modified contents in a modification log file, are provided.

### BACKGROUND OF THE INVENTION

This application claims the benefit of a Japanese Patent Application No. 2002-298826 filed Oct. 11, 2002, in the Japanese Patent Office, the disclosure of which is hereby incorporated by reference.

1. Field of the Invention

The present invention generally relates to log management apparatuses and storage media, and more particularly to a log management apparatus for managing a log of file operations performed in a client-server system, and to a computer-readable storage medium which stores a computer program for causing a computer to manage a log of such file operations.

2. Description of the Related Art

In open-type client-server systems typified by WINDOWS (registered trademark) and UNIX (registered trademark), a plurality of resources such as computers and files are connected via one or more networks. These resources are frequently modified by users. Modification of the resources include addition, deletion, correction and the like of the resources.

In the client-server system described above, it is extremely difficult to constantly grasp in real-time changes in the states of the files in the client-server system because a plurality of users make access to the files (hereinafter referred to as file operations) at arbitrary timings. For this reason, it is difficult to manage a log which follows the file operations under such difficult conditions where the environment constantly changes. However, the log of the file operations includes information which is necessary to specify a cause of a trouble at the time of trouble-shooting, and thus, it is desirable to accurately manage the log of the file operations.

According to a first example of the prior art, modification information of the modified file is stored in a backup file every time the file is modified, as in the case of EMAX of a UNIX editor, for example. According to this first example, it is possible to manage the modification information of the modified files. However, a special operation is required to store the modification information in the back-up file, and the user must be skilled, that is, possess knowledge of the system and be familiar with the system, in order to be able to perform this special operation. Consequently, this first example is unsuited for the general user who may not be familiar with the system.

On the other hand, according to a second example of the prior art, log information with respect to the file operation is managed in a file server. Such a system is proposed in a Japanese Laid-Open Patent Application No. 6-202926 (see page 11 and FIGS. 9 and 10 thereof, for example). The log information includes a file operator name, an operated file name, a kind of operation, an operated time and the like.

Furthermore, according to a third example of the prior art, the log information with respect to the file operation is also managed in the file server, and such a system is proposed in a Japanese Laid-Open Patent Application No. 6-67956 (see page 3 and FIG. 2 thereof, for example).

Therefore, in the case of the first example of the prior art, the user must be skilled in order to be able to perform the special operation for storing the modification information in the backup file, thereby making this first example unsuited for the general user. In addition, since the special operation is a manual operation performed by the user, there is a possibility of storing erroneous modification information if the user makes an error. For this reason, there were problems in that the log of the modification information of the file operations cannot be managed without user intervention (that is, without requiring the user to be aware of the log information to be managed), and that it is difficult to guarantee the accuracy of the log.

On the other hand, in the case of the second example of the prior art, the log information such as the file operator name, the operated file name, the kind of operation and the operated time are managed for each file operation. However, log information of modification contents to the level of items within the file is not managed. Accordingly, there was a problem in that the information necessary to specify the cause of the trouble at the time of the trouble-shooting is not sufficiently included in the log information. Moreover, since the targets of the log management are the files within the file server accessed in common from the clients, there was a problem in that the log management cannot be made with respect to the file operation at the client.

Furthermore, in the case of the third example of the prior art, the log information indicating the correction, addition and the like with respect to a region within the file is managed for the file operation, but the log information of the modification contents to the level of items within the file is not managed, similarly as in the case of the second example of the prior art described above. Consequently, there was a problem in that the information necessary to specify the cause of the trouble at the time of the troubleshooting is not sufficiently included in the log information. In addition, because the targets of the log management are the files within the file server accessed in common from the clients, there was a problem in that the log management cannot be made with respect to the file operation at the client.

### SUMMARY OF THE INVENTION

Accordingly, it is a general object of the present invention to provide a novel and useful log management apparatus and computer-readable storage medium, in which the problems described above are eliminated.

Another and more specific object of the present invention is to provide a log management apparatus and a computer-readable storage medium, which automatically manages log information related to file operations with respect to a plurality of files existing in one or more networks using a simple structure, without user intervention (that is, without requiring the user to be aware of the log information to be managed), and includes detailed information related to the file operations in the log information so that information necessary to specify a cause of a trouble at the time of a trouble-shooting is sufficiently included in the log information.

Still another object of the present invention is to provide a log management apparatus which is coupled to a plurality of terminal equipments via at least one network and manages a log of a file operation performed from one of the plurality of terminal equipments with respect to a file of another one of the plurality of terminal equipments, comprising an input and output section to obtain data via the network, and to obtain and store trace data in a trace file by starting a trace in response to a file operation; an extracting section to automatically extract predetermined modified contents with respect to a file from the trace file; and a storing section to store the predetermined modified contents in a modification log file. According to the log management apparatus of the present invention, it is possible to automatically manage log information related to file operations with respect to a plurality of files existing in one or more networks using a simple structure, without user intervention (that is, without requiring the user to be aware of the log information to be managed), and to include detailed information related to the file operations in the log information so that information necessary to specify a cause of a trouble at the time of a trouble-shooting is sufficiently included in the log information.

A further object of the present invention is to provide a computer-readable storage medium storing a program for causing a computer which is coupled to a plurality of terminal equipments via at least one network to manage a log of a file operation performed from one of the plurality of terminal equipments with respect to a file of another one of the plurality of terminal equipments, the program comprising an input and output procedure causing the computer to obtain data via the network, and to obtain and store trace data in a trace file by starting a trace in response to a file operation; an extracting procedure causing the computer to automatically extract predetermined modified contents with respect to a file from the trace file; and a storing procedure causing the computer to store the predetermined modified contents in a modification log file. According to the computer-readable storage medium of the present invention, it is possible to automatically manage log information related to file operations with respect to a plurality of files existing in one or more networks using a simple structure, without user intervention (that is, without requiring the user to be aware of the log information to be managed), and to include detailed information related to the file operations in the log information so that information necessary to specify a cause of a trouble at the time of a trouble-shooting is sufficiently included in the log information.

Other objects and further features of the present invention will be apparent from the following detailed description when read in conjunction with the accompanying drawings.

### BRIEF DESCRIPTION OF THE DRAWINGS

FIG. 1 is a functional block diagram showing a client-server system to which an embodiment of a log management apparatus according to the present invention is applied;

FIG. 2 is a flow chart for explaining a process of a network data input and output section;

FIG. 3 is a diagram showing an embodiment of a data structure within a trace file;

FIG. 4 is a flow chart for explaining a process of a modified content portion extracting section;

FIG. 5 is a diagram showing an embodiment of a data structure within a template;

FIG. 6 is a diagram for explaining kinds of templates when using UNIX commands;

FIG. 7 is a diagram showing an embodiment of a data structure within a storage file;

FIG. 8 is a diagram showing a file before editing and a file after editing;

FIG. 9 is a diagram showing trace data stored within the trace file;

FIG. 10 is a diagram showing the trace data stored within the trace file;

FIG. 11 is a flow chart for explaining a process of a log information storing section;

FIG. 12 is a diagram showing an embodiment of a data structure within a temporary file;

FIG. 13 is a diagram showing an embodiment of a data structure within a modification log file;

FIG. 14 is a flow chart for explaining a process of a modification log analyzing comment display section;

FIG. 15 is a diagram showing an embodiment of a display screen displayed on a terminal equipment; and

FIG. 16 is a diagram showing an embodiment of a display screen of modification log information.

### DESCRIPTION OF THE PREFERRED EMBODIMENTS

A description will be given of embodiments of a log management apparatus according to the present invention and a computer-readable storage medium according to the present invention, by referring to the drawings.

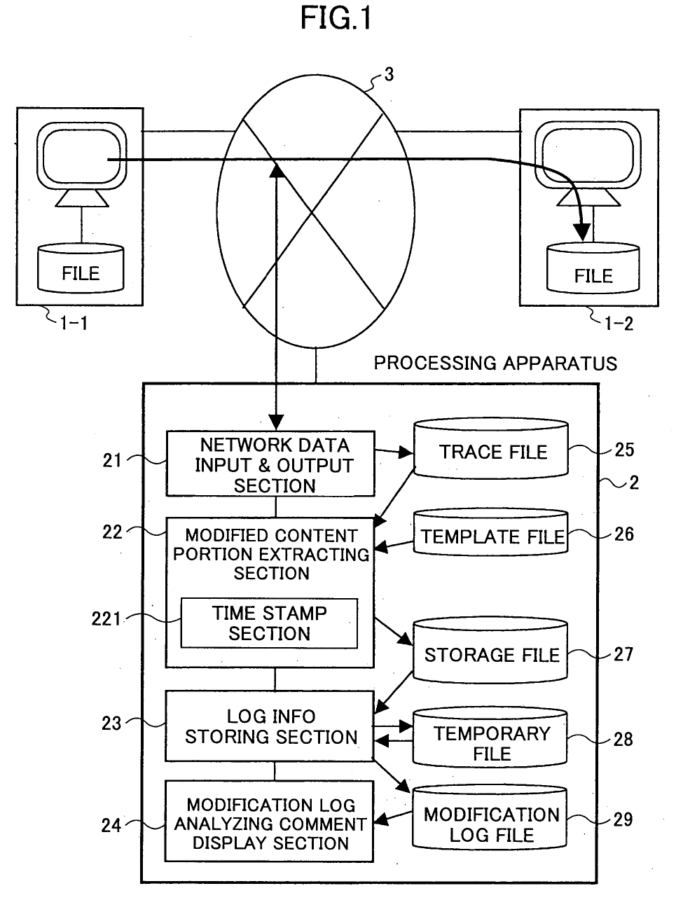

FIG. 1 is a functional block diagram showing a client-server system to which an embodiment of the log management apparatus according to the present invention is applied. This embodiment of the log management apparatus employs an embodiment of the computer-readable storage medium according to the present invention.

In the client-server system shown in FIG. 1, a plurality of terminal equipments 1-1 and 1-2 and a processing apparatus 2 are connected via a network 3. Only two terminal equipments 1-1 and 1-2 are shown in FIG. 1 for the sake of convenience, but it is of course possible to provide three or more terminal equipments. Each of the terminal equipments 1-1 and 1-2 corresponds to a client, and may be formed by a known general purpose computer such as a personal computer. The processing apparatus 2 corresponds to a server, and may be formed by a known general purpose computer such as a personal computer. The log management apparatus is formed by at least a part of the processing apparatus 2. The network 3 may be formed by one or a plurality of cable networks and/or wireless networks, and may include the Internet or the like.

The processing apparatus 2 includes a network data input and output section 21, a modified content portion extracting section 22, a log information storing section 23, a modification log analyzing comment display section 24, a trace file 25, a template file 26, a storage file 27, a temporary file 28, and a modification log file 29.

The modified content portion extracting section 22 includes a time stamp section 221. The network data input and output section 21, the modified content portion extracting section 22, the log information storing section 23 and the modification log analyzing comment display section 24 are formed by one or a plurality of processors, such as CPUs, within the computer forming the processing apparatus 2.

This embodiment of the computer-readable storage medium stores a computer program for causing the one or plurality of processors, such as the CPUs, within the computer forming the processing apparatus 2, to operate as this embodiment of the log management apparatus. A recording medium forming the computer-readable storage medium is not limited to a particular type, and may be any kind of media capable of storing the computer program. Magnetic, optical and magneto-optical recording media, and semiconductor memory devices may be used for the recording medium. The recording medium may be fixedly provided within the computer or, may be portable such that the recording medium can be loaded into and unloaded from the computer. The computer program may be installed in the computer via the computer-readable storage medium or, downloaded from another computer via the network 3.

The trace file 25, the template 26, the storage file 27, the temporary file 28 and the modification log file 29 are formed by one or a plurality of storage units (or devices) within the computer forming the processing apparatus 2. Each storage unit may be formed by a semiconductor memory device, a disk drive or the like. In addition, at least a part of the storage unit may be externally connected to the computer forming the processing apparatus 2.

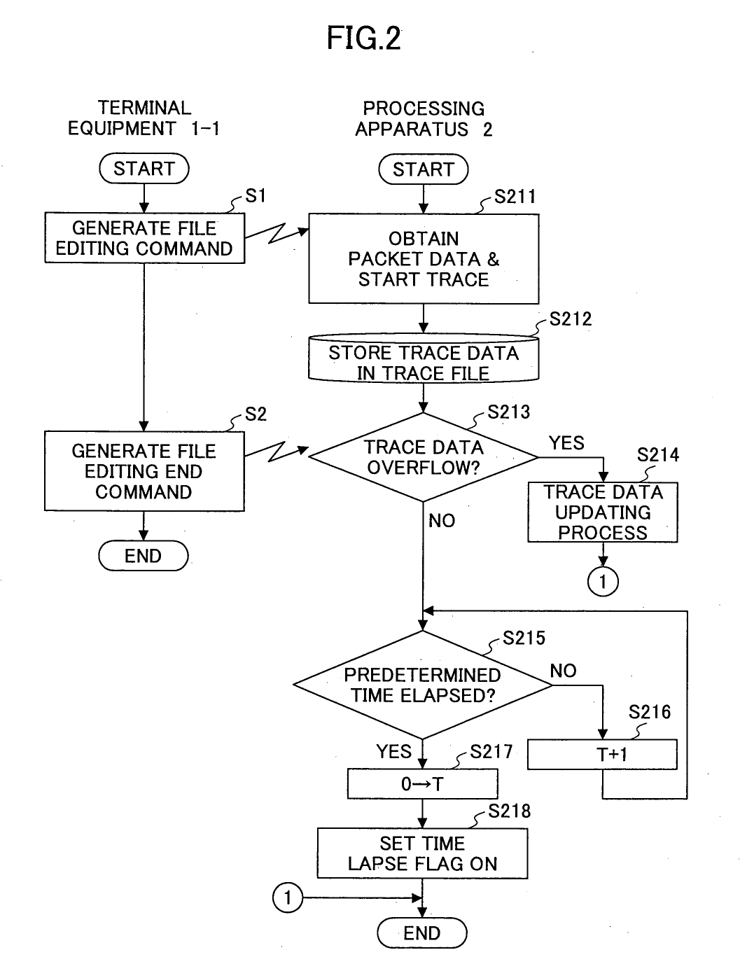

FIG. 2 is a flow chart for explaining a process of the network data input and output section 21. For the sake of convenience, it is assumed in this embodiment that the terminal equipment 1-1 carries out a file editing with respect to a file within the terminal equipment 1-2. In FIG. 2, a process of the terminal equipment 1-1 is shown on the left side, and a process of the network data input and output section 21 of the processing apparatus 2 is shown on the right side. The file editing (file operation) itself which is performed from the terminal equipment 1-1 with respect to the file of the terminal equipment 1-2 is known, and a description thereof will be omitted.

In FIG. 2, a step Si generates a file editing command in the terminal equipment 1-1 as one example of the file operation. In addition, a file editing operation (not shown) is carried out in the terminal equipment 1-1, and the process of the terminal equipment 1-1 is ended when a file editing end command is generated in a step S2.

On the other hand, in the processing apparatus 2, a step S211 constantly monitors the network 3 so as to obtain packet data transferred through the network 3, and starts a trace to obtain trace data when the file editing command is generated in the step S1. A step S212 stores the trace data within the obtained packet data in the trace file 25. The tracing of the data is continued during the file editing, that is, during the file operation.

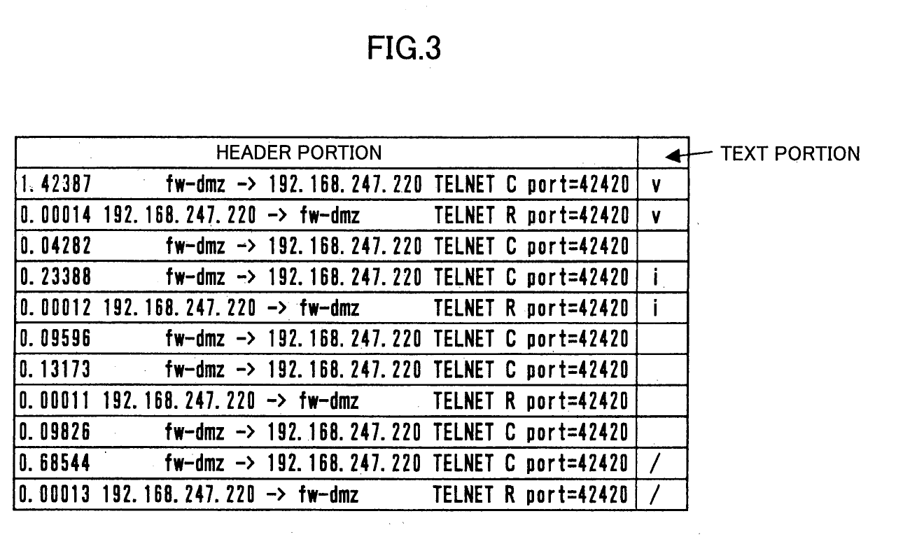

FIG. 3 is a diagram showing an embodiment of a data structure within the trace file 25. As shown in FIG. 3, the trace file 25 has a data structure made up of a header portion and a text portion.

A step S213 decides whether or not an overflow of the trace data occurred in the trace file. 25. If the decision result in the step S213 is YES, a step S214 carries out a trace data updating process to eliminate the overflow within the trace file 25, and the process ends. For example, the trace data updating process switches a storage region for the trace file 25 from a first region to a second region, and deletes the data within the first region after the switching.

On the other hand, if the decision result in the step S213 is NO, a step S215 decides whether or not a predetermined time corresponding to an arbitrary processing unit has elapsed, based on a comparison of a counter value T and a threshold value. If the decision result in the step S215 is YES, a step S217 resets the counter value T to 0, and the process advances to a step S218. The step S218 sets a time lapse flag ON to indicate that the predetermined time described above has elapsed.

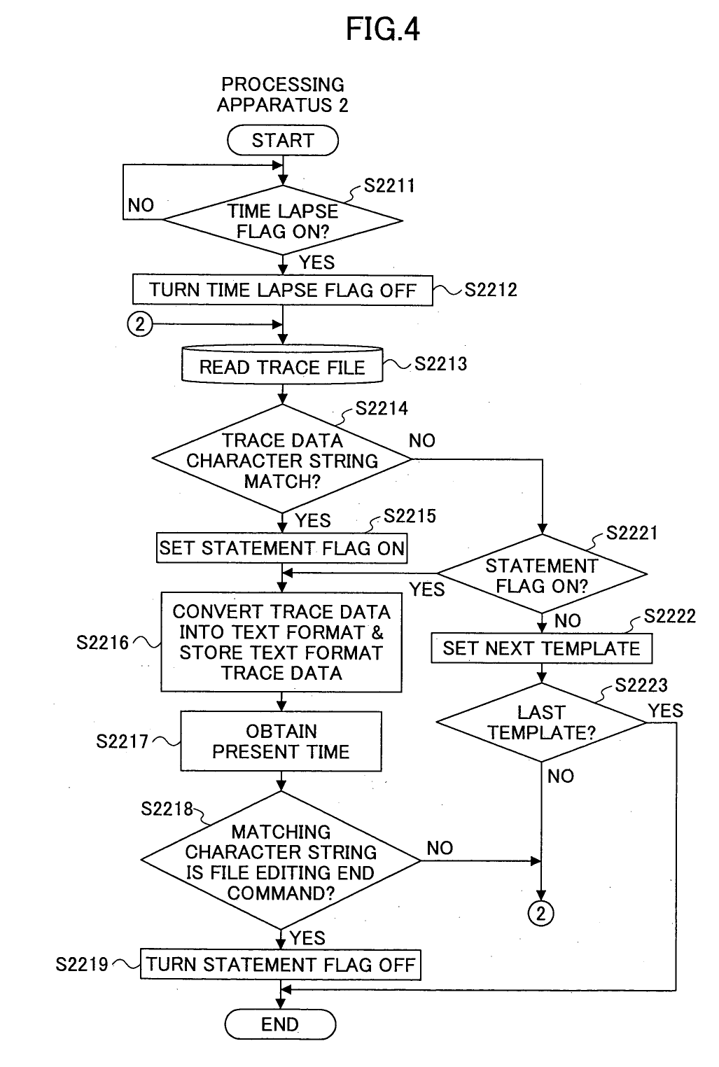

FIG. 4 is a flow chart for explaining a process of the modified content portion extracting section 22. For example, the process shown in FIG. 4 is started when the file editing end command is generated in the step S2 shown in FIG. 2, that is, when the file operation ends.

In FIG. 4, a step S2211 decides whether or not the time lapse flag is ON. If the decision result in the step S2211 is YES, a step S2212 turns the time lapse flag OFF. A step S2213 reads the trace file 25, and a step S2214 decides whether or not the trace data of the trace file 25 and a character string of a template of the template file 26 match. The template has a data format for each network protocol employed by the network 3.

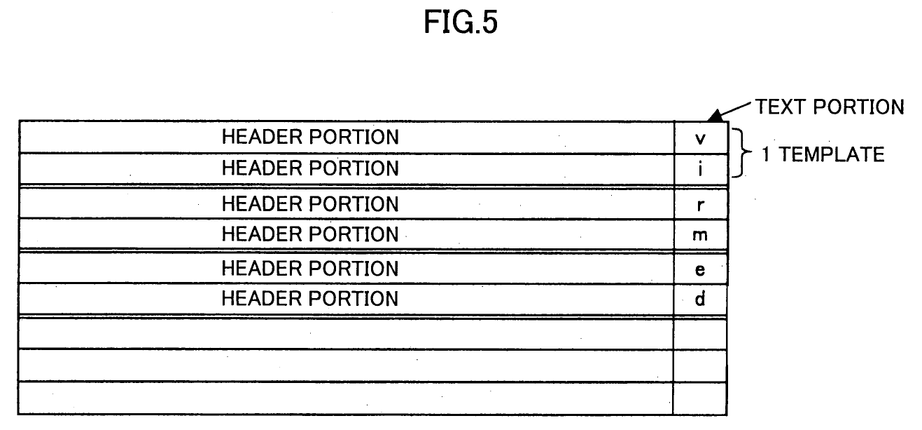

FIG. 5 is a diagram showing an embodiment of a data structure within a template of the template file 26. As shown in FIG. 5, the template of the template file 26 has a data structure made up of a header portion and a text portion. In FIG. 5, a portion defined between two adjacent double-lines indicates one template.

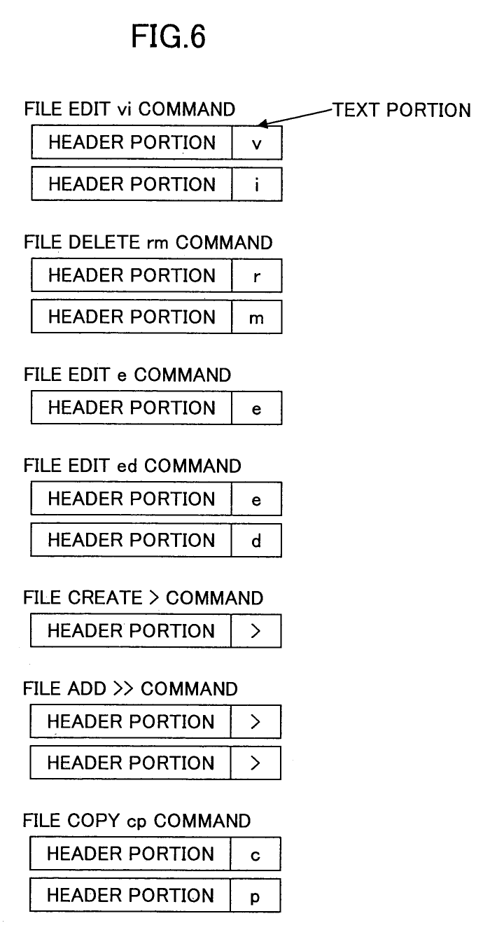

FIG. 6 is a diagram for explaining kinds of templates when using UNIX commands. As shown in FIG. 6, the kinds of templates for the case where the UNIX commands are used include a file edit vi command, a file delete rm command, a file edit e command, a file edit ed command, a file create> command, a file add>> command, and a file copy cp command.

If the decision result in the step S2214 shown in FIG. 4 is YES, a step S2215 sets a statement flag ON. This statement flag is used to judge one line of the trace data. A step S2216 converts the trace data into text format, and stores the text format trace data in the storage file 27. In addition, a step S217 obtains the present time from the time stamp section 221, and stores the present time in the storage file 27 in correspondence with the trace data.

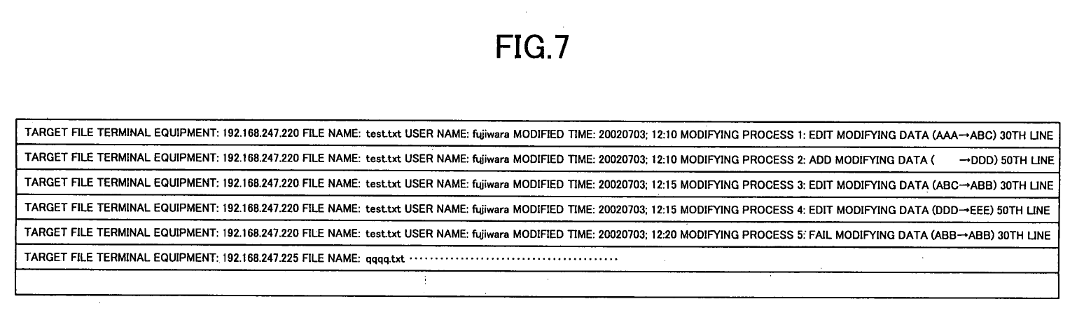

FIG. 7 is a diagram showing an embodiment of a data structure within the storage file 27. As shown in FIG. 7, the trace data is stored in the text format within the storage file 27. In FIG. 7, a target file terminal equipment refers to a terminal equipment having the file which is the target of the file operation, that is, the terminal equipment 1-2 in the case of this embodiment. In addition, a user name indicates the name of the user who performs the file operation, and is the name of the user of the terminal equipment 1-1 in the case of this embodiment. Moreover, a modifying process indicates the kind of file operation (file editing), and a modifying data indicates the state of the data, which is to be modified, before and after the modification.

A step S2218 shown in FIG. 4 decides whether or not the character string of the template of the template file 26 matching the trace data in the step S2214 is the file editing end command. The process returns to the step S2213 if the decision result in the step S2218 is NO. On the other hand, if the decision result in the step S2218 is YES, a step S2219 turns the statement flag OFF, and the process ends.

If the decision result in the step S2214 is NO, a step S2221 decides whether or not the statement flag is ON. The process advances to a step S2216 if the decision result in the step S2221 is YES. If the decision result in the step S2221 is NO, a step S2222 sets a next template of the template file 26. A step S2223 decides whether or not the set template is the last template of the template file 26, and the process returns to the step S2213 if the decision result in the step S2223 is NO. On the other hand, the process ends if the decision result in the step S2223 is YES.

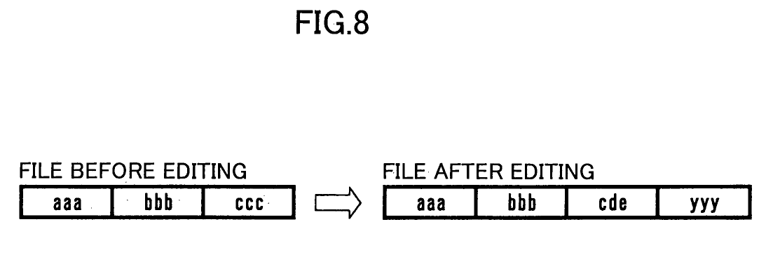

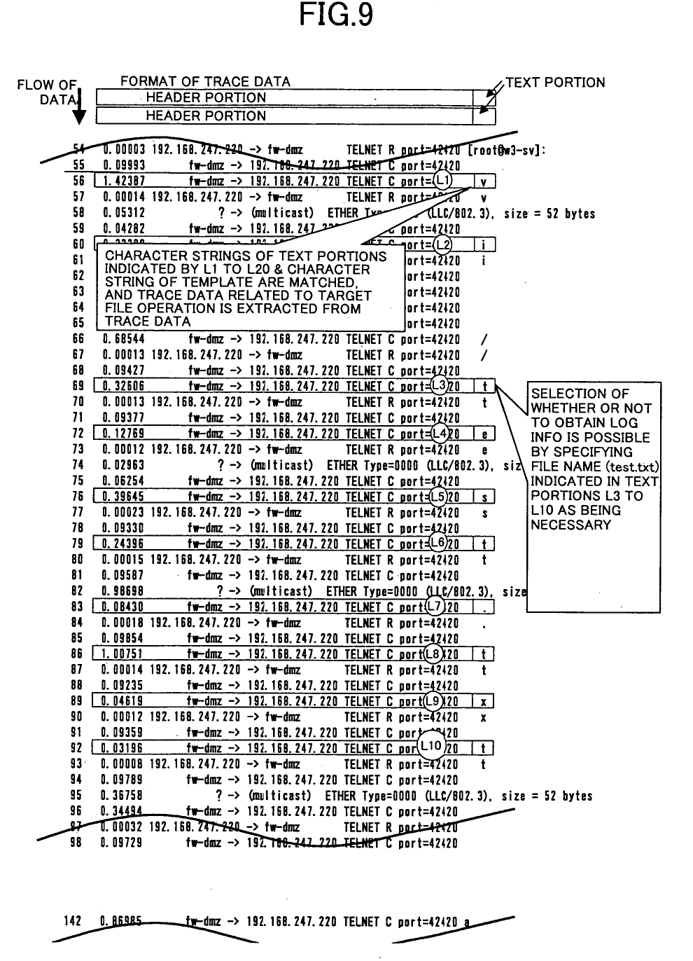

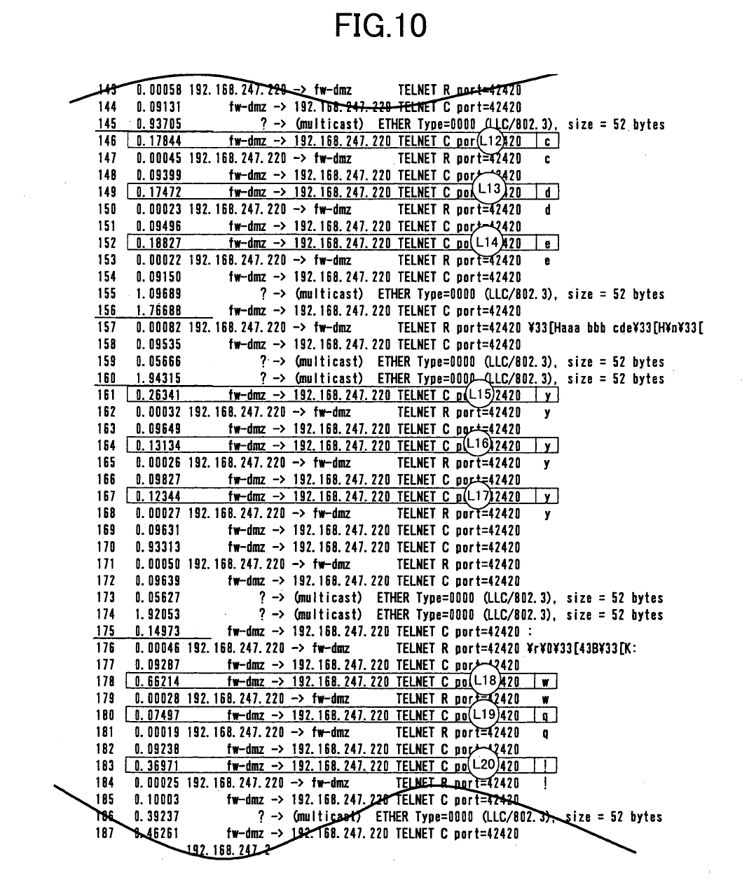

FIG. 8 is a diagram showing the file before the editing and the file after the editing. The state before the modification is shown on the left side of FIG. 8, and the state after the modification is shown on the right side of FIG. 8. FIGS. 9 and 10 are diagrams showing trace data stored within the trace file 25.

Accordingly, in a case where the file before the editing is “aaa, bbb, ccc” and the file after the editing is “aaa, bbb, cde, yyy” as shown in FIG. 8, and the trace data shown in FIGS. 9 and 10 are stored in the trace file 25, the character strings of the text portions indicated by L1 through L10 are compared with the character string of the template of the template file 26. The trace data having the character string matching the template is extracted as the trace data related to the target file operation. By specifying a file test.txt indicated in the text portions L3 through L10 as being necessary, it is possible to select whether or not to obtain the log information.

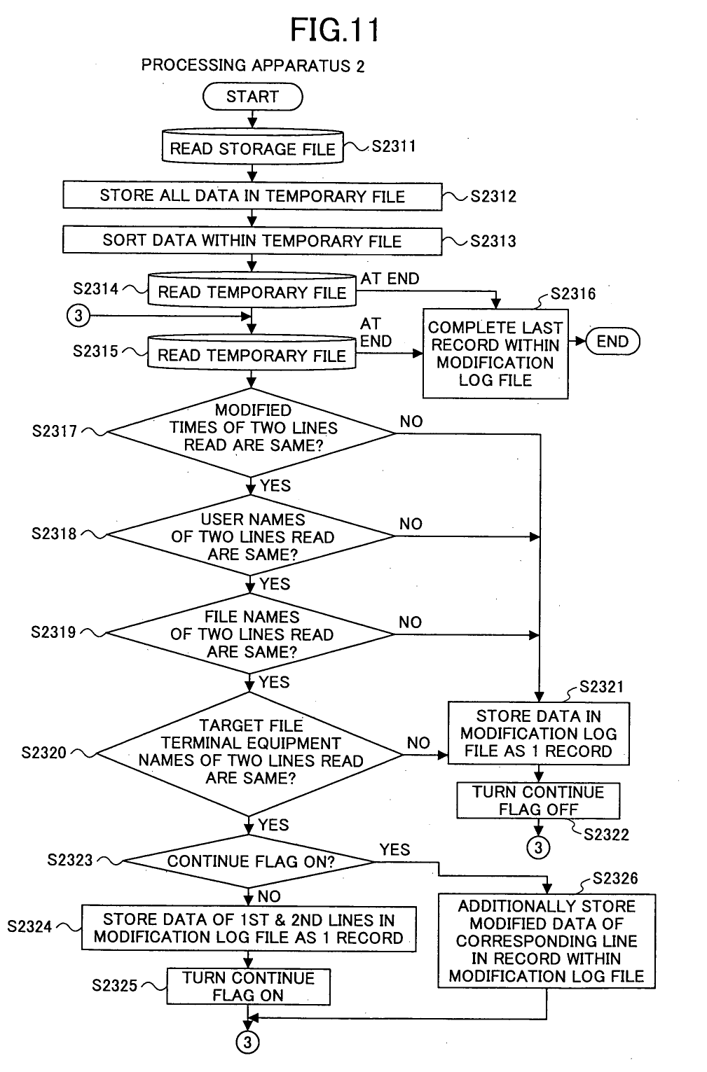

FIG. 11 is a flow chart for explaining a process of the log information storing section 23. In FIG. 11, a step S2311 reads the storage file 27, and a step S2312 stores all of the data read from the storage file 27 in the temporary file 28. A step S2313 sorts the data within the temporary file 28 in an order of the modified time, the user name, the file name, and the target file terminal equipment name.

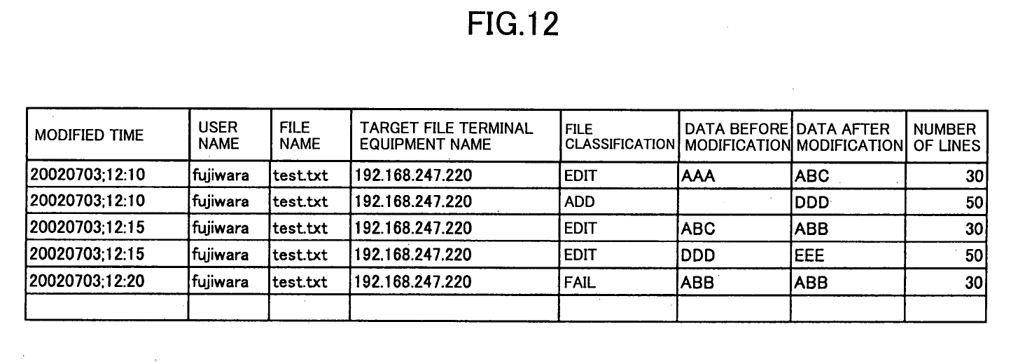

FIG. 12 is a diagram showing an embodiment of a data structure within the temporary file 28A. As shown in FIG. 12, the modified time, the user name, the file name, the target file terminal equipment name, the file classification, the data before modification, the data after modification, and the number of lines of each data are stored within the temporary file 28.

A step S2314 shown in FIG. 11 reads from the temporary file 28 one line of the data sorted in the step S2313. After the reading of the last line of the temporary file 28 ends, a step S2316 completes the last record within the modification log file 29, and the process ends.

A step S2315 reads from the temporary file 28 the next one line of the data sorted in the step S2313. After the reading of the last line of the temporary file 28 ends, the step S2316 completes the last record within the modification log file 29, and the process ends.

A step S2317 decides whether or not the modified times of the two lines which are read are the same. If the decision result in the step S2317 is YES, a step S2318 decides whether or not the user names of the two lines which are read are the same. If the decision result in the step S2318 is YES, a step S2319 decides whether or not the file names of the two lines which are read are the same. If the decision result in the step S2319 is YES, a step S2320 decides whether or not the target file terminal equipment names of the two lines which are read are the same. On the other hand, if the decision result in the step S2317, S2318, S2319 or S2320 is NO, a step S2321 stores the data which is read first or the data which is read immediately before into the modification log file 29 as one record. After the step S2321, a step S2322 turns OFF a continue flag which indicates that the data is included in one record, and the process returns to the step S2315.

On the other hand, if the decision result in the step S2320 is YES, a step S2323 decides whether or not the continue flag is ON. If the decision result in the step S2323 is NO, a step S2324 stores the data of the first and second lines in the modification log file 29 as one record having the same modified time, user name, file name and target file terminal equipment name. A step S2325 turns the continue flag ON, and the process returns to the step S2315. If the decision result in the step S2323 is YES, a step S2326 additionally stores the modified data of the corresponding line in the record within the modification log file 29, and the process returns to the step S2315.

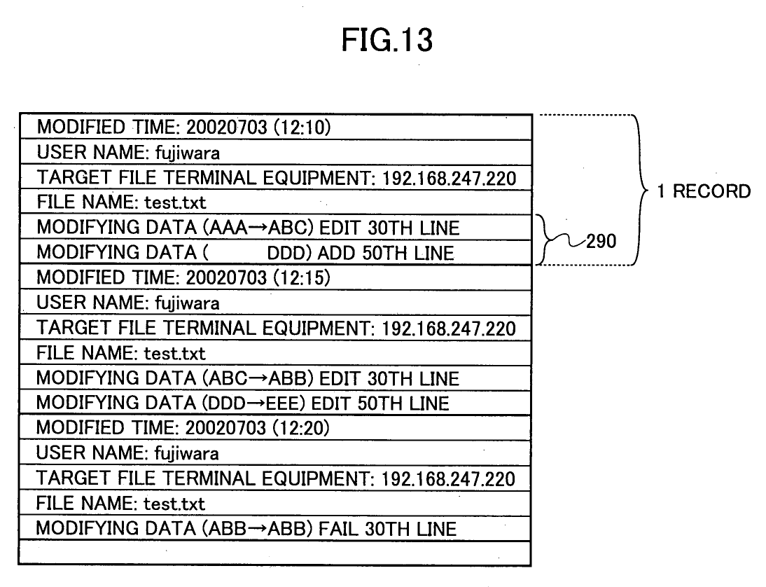

FIG. 13 is a diagram showing an embodiment of a data structure within the modification log file 29. In FIG. 13, a bold solid line indicates a boundary of the records. In addition, a reference numeral 290 indicates a portion where a computer-assisted name identification is made with respect to the log of the file operations performed at the same time band. The number of lines in this portion 290 is variable. As shown in FIG. 13, the modification log file 29 stores modification log information in the text format, that is, stores the information in units of lines and in units of words. In addition, the end of each item of the modification log information is formed by a specific code such as a space, colon and bracket.

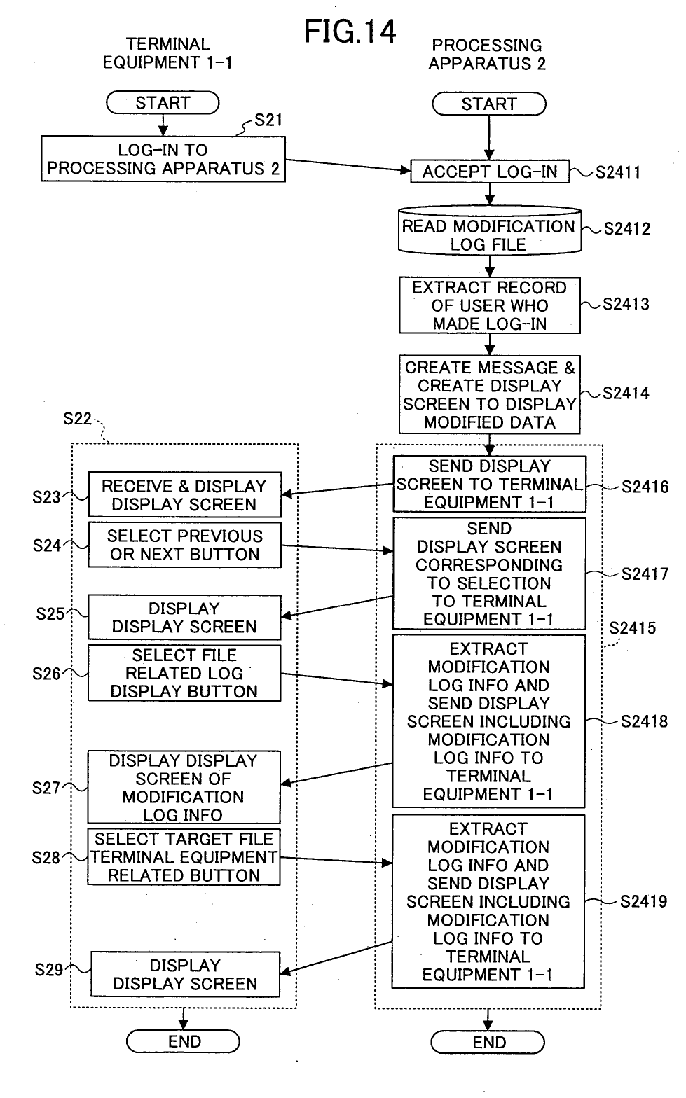

FIG. 14 is a flow chart for explaining a process of the modification log analyzing comment display section 25. In FIG. 14, the left side shows the process of the terminal equipment 1-1, and the right side shows the process of the network data input and output section 21.

In the terminal equipment 1-1, when a log-in is made to the processing apparatus 2 in a step S21 shown in FIG. 14, the process of the processing apparatus 2 is started from a step S2411.

In the processing apparatus 2, the step S2411 accepts the log-in from the terminal equipment 1-1, and a step S2412 reads the modification log file 29. A step S2413 extracts from the read modification log file 29 the record corresponding to the user name of the user who made the log-in. If an abnormal file operation (abnormal operation) such as a file operation failure exists in the record which is extracted in the step S2413, a step S2414 creates an appropriate message (comment), and creates a display screen which is set to display the modified data line with emphasis, for example. Thereafter, the process advances to a step S2415, and interactive processes are carried out between a step S22 of the terminal equipment 1-1 and a step S2415 of the processing apparatus 2.

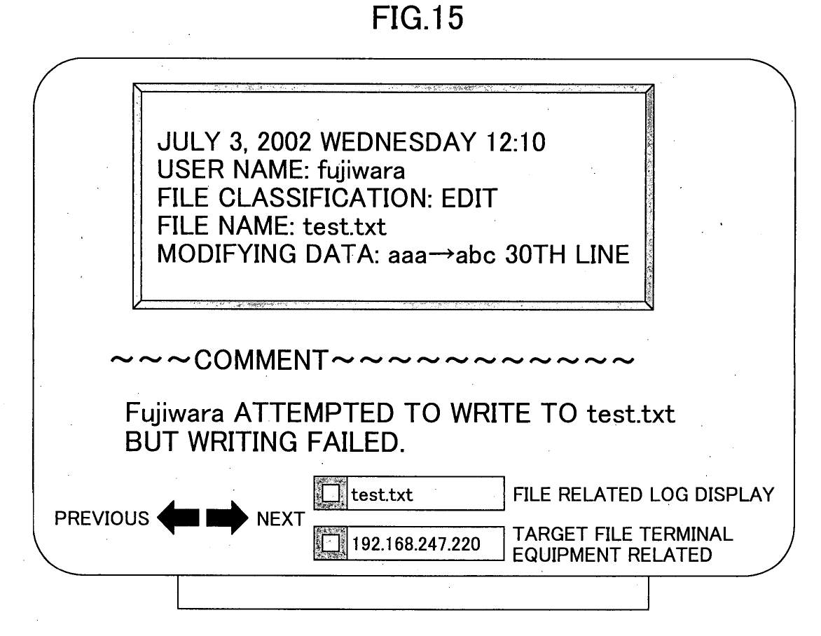

More particularly, in the processing apparatus 2, the step S2416 sends the display screen created in the step S2414 to the terminal equipment 1-1, and in the terminal equipment 1-1, a step S23 receives and displays the display screen. FIG. 15 is a diagram showing an embodiment of the display screen displayed on the terminal equipment 1-1. In the display screen shown in FIG. 15, the items including the date, the user name, the file category, the file name and the modified data are displayed in the upper portion of the display screen. The number of lines is displayed under the item “modified data”, so that when the user performs the file operation on his terminal equipment, the order of the command line displayed on the display screen of this terminal equipment in response to the file operation can be matched to the number of lines. As a result, the user can later visually confirm the corresponding relationship of the file operation performed by the user and the command lines, so as to enable easy confirmation of the cause of the trouble when making the trouble-shooting.

In FIG. 15, the comment is displayed at the central portion of the display screen. In this case, it is described in the comment that the user having the user name “Fujiwara” attempted to write to the file test.txt but the writing failed. In addition, a “previous” button, a “next” button, a “file related log display” button, and a “target file terminal equipment related” button are displayed in the lower portion of the display screen. The information which is to be displayed may be specified by selecting the “previous” or “next” button by an input device such as a mouse of the terminal equipment 1-1. Accordingly, the computer-assisted name identification may be made with respect to the specified file name, so as to display only the log information of the file operation with respect to the corresponding file. In addition, it is also possible to display and confirm the log information of a plurality of file operations with respect to the corresponding file. In this case, the log information of the plurality of file operations with respect to one file may be displayed in the order of elapsed time or, only the modified portion may be extracted and displayed. Similarly, it is also possible to display the log information of the file operations limited to the terminal equipments in which the files exist.

In the terminal equipment 1-1, when the “previous” or “next” button is selected in a step S24, the processing apparatus 2 sends the display screen corresponding to this selection (or request) to the terminal equipment 1-1 in a step S2417, in response to this selection (or request) made in the step S24. Hence, in the terminal equipment 1-1, the display screen described above is displayed in a step S25.

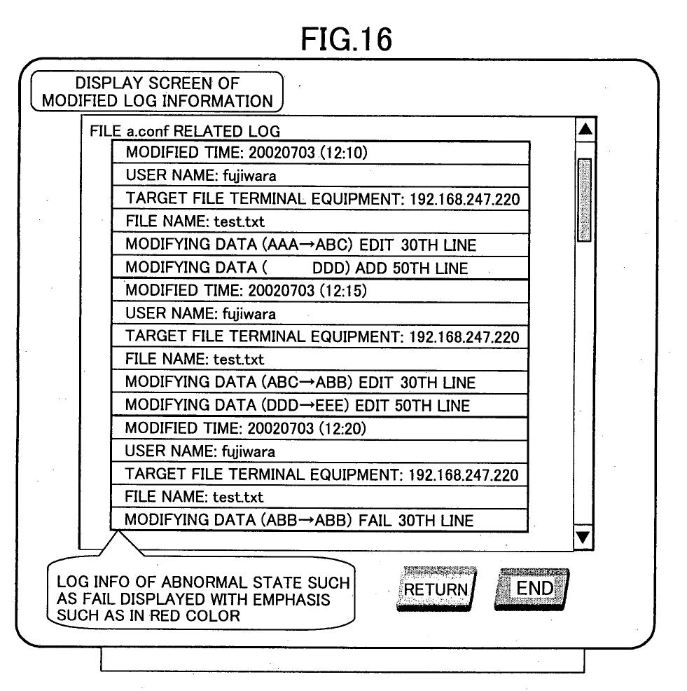

In the terminal equipment 1-1, if the file name is set to test.txt and the “file related log display” button is selected in a step S26, for example, the processing apparatus 2 extracts the modification log information of the selected (or requested) file name and sends the display screen including this modification log information to the terminal equipment 1-1 in a step S2418, in response to this selection (request) made in the step S26. Thus, in the terminal equipment 1-1, a display screen of the modification log information shown in FIG. 16 which is received is displayed in a step S27. FIG. 16 is a diagram showing an embodiment of the display screen of the modification log information. As shown in FIG. 16, the modification log information, which is displayed if necessary, displays the modified contents due to the file operation in the text format so as to facilitate the user's understanding of the modification log information.

Furthermore, in the terminal equipment 1-1, when the target file terminal equipment name is set to 192.168.247.220 and the “target file terminal equipment related” button is selected in a step S28, for example, the processing apparatus 2 extracts the modification log information by making the computer-assisted name identification by the specified target file terminal equipment name and sends the display screen including this modification log information to the terminal equipment 1-1 in a step S2419, in response to the setting and selection (or request) made in the step S28. The process of the processing apparatus 2 ends thereafter. On the other hand, in the terminal equipment 1-1, a display screen similar to the display screen of the modification log information shown in FIG. 16 is displayed in a step S29, and the process ends.

By managing the log information in the above described manner, even if the file name is modified, for example, it is possible to positively and accurately manage the log information. In addition, it is possible to positively and accurately manage the log information without user intervention, thereby enabling an accurate trouble-shooting within a short time using the accurately managed log information.

Moreover, the system to which the present invention may be applied is not limited to the client-server system. The present invention is applicable to any system having a structure in which a plurality of computers (or terminal equipments) are connected via one or more networks. In this case, at least one of the plurality of computers (or terminal equipments) simply needs to function as the server (processing apparatus 2).

In the embodiment described heretofore, it is assumed for the sake of convenience that the file operation is performed from the terminal equipment 1-1 with respect to the file in the terminal equipment 1-2. However, the present invention is of course similarly applicable to a case where the file operation is performed from the terminal equipment 1-1 or 1-2 with respect to the file in the processing apparatus 2.

Further, the present invention is not limited to these embodiments, but various variations and modifications may be made without departing from the scope of the present invention.

What is claimed is

1. A log management apparatus which is coupled to a plurality of terminal equipments via at least one network and manages a log of a file operation performed from one of the plurality of terminal equipments with respect to a file of another one of the plurality of terminal equipments, comprising:
an input and output section to obtain data via the network, and to obtain and store trace data in a trace file by starting a trace in response to a file operation;
an extracting section to automatically extract predetermined modified contents with respect to a file from the trace file; and
a storing section to store the predetermined modified contents in a modification log file.

2. The log management apparatus as claimed in claim 1, further comprising:
a template file to store a template having a data format for each network protocol employed by the network,
said extracting section extracting the predetermined modified contents based on a comparison of the trace data within the trace file and the template within the template file.

3. The log management apparatus as claimed in claim 2, wherein the template includes at least one of a file edit command, a file delete command, a file create command and a file copy command.

4. The log management apparatus as claimed in claim 1, wherein said storing section stores the predetermined modified contents in the modification log file in a text format.

5. The log management apparatus as claimed in claim 1, wherein the predetermined modified contents stored in the modification log file by said storing section includes a modified position and modified content with respect to the file.

6. The log management apparatus as claimed in claim 1, wherein:
said extracting section stores the predetermined modified contents in a storage file in a text format in response to an end of the file operation; and
said storing section stores the predetermined modified contents in the modification log file in a text format based on the storage file.

7. The log management apparatus as claimed in claim 1, further comprising:
a display section to send a display screen which is based on the modification log file to an arbitrary one of the plurality of terminal equipments via the network, in response to a request from the arbitrary one of the plurality of terminal equipments.

8. The log management apparatus as claimed in claim 7, wherein said display section includes a message which indicates an existence of an abnormal operation in the display screen, if the abnormal operation exists in the modification log file.

9. The log management apparatus as claimed in claim 1, wherein the log management apparatus is formed by at least one of the plurality of terminal equipments.

10. A computer-readable storage medium storing a program for causing a computer which is coupled to a plurality of terminal equipments via at least one network to manage a log of a file operation performed from one of the plurality of terminal equipments with respect to a file of another one of the plurality of terminal equipments, said program comprising:
an input and output procedure causing the computer to obtain data via the network, and to obtain and store trace data in a trace file by starting a trace in response to a file operation;
an extracting procedure causing the computer to automatically extract predetermined modified contents with respect to a file from the trace file; and
a storing procedure causing the computer to store the predetermined modified contents in a modification log file.

11. The computer-readable storage medium as claimed in claim 10, wherein said extracting procedure causes the computer to extract the predetermined modified contents based on a comparison of the trace data within the trace file and a template having a data format for each network protocol employed by the network.

12. The computer-readable storage medium as claimed in claim 11, wherein the template includes at least one of a file edit command, a file delete command, a file create command and a file copy command.

13. The computer-readable storage medium as claimed in claim 10, wherein said storing procedure causes the computer to store the predetermined modified contents in the modification log file in a text format.

14. The computer-readable storage medium as claimed in claim 10, wherein the predetermined modified contents stored in the modification log file by said storing procedure includes a modified position and modified content with respect to the file.

15. The computer-readable storage medium as claimed in claim 10, wherein:
said extracting procedure causes the computer to store the predetermined modified contents in a storage file in a text format in response to an end of the file operation; and
said storing procedure causes the computer to store the predetermined modified contents in the modification log file in a text format based on the storage file.

16. The computer-readable storage medium as claimed in claim 10, wherein the program further comprises:
a display procedure causing the computer to send a display screen which is based on the modification log file to an arbitrary one of the plurality of terminal equipments via the network, in response to a request from the arbitrary one of the plurality of terminal equipments.

17. The computer-readable storage medium as claimed in claim 16, wherein said display procedure causes the computer to include a message which indicates an existence of an abnormal operation in the display screen, if the abnormal operation exists in the modification log file.
